(19) United States
(12) Patent Application Publication
(10) Pub. No.: US 2009/0021033 A1
(43) Pub. Date: Jan. 22, 2009

(54) Illuminated magnifying tweezers

(75) Inventor: Anand Khubani, Towaco, NJ (US)

Correspondence Address: EPSTEIN DRANGEL BAZERMAN & JAMES, LLP, 60 EAST 42ND STREET, SUITE 820, NEW YORK, NY, 10165, US

(73) Assignee: Ideavillage Products Corp.

(21) Appl. No.: 11/879,298

(22) Filed: Jul. 17, 2007

(51) Int. Cl. B25B 9/02

(52) U.S. Cl. 294/99.2

(57) ABSTRACT

The tweezers include first and second elongated object retaining members. Each of the retaining members has a forward section and a rear section. A body is situated between the retaining members. The forward sections of the retaining members are movable between a position remote from each other and a position wherein the forward sections are proximate to each other, so as to retain an object therebetween. The body includes means for illuminating an object retained by the retaining members. The body also carries a magnifying lens and means for mounting the lens on the body for movement between a position aligned with the retained object and a position remote from the retained object. The present invention permits the user to illuminate and magnify a retained object using one hand, while the other hand is free to perform other tasks.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to tweezers and more particularly to tweezers that are capable of illuminating and magnifying an object retained by the tweezers at the same time.

2. Description of Prior Art Including Information Disclosed Under 37 CFR 1.97 and 1.98

Tweezers with attached magnifying lenses have been known in the art. For example, see Cusimano U.S. Pat. No. 1,516,955; Fleenor U.S. Pat. No. 2,435,741; Jack U.S. Pat. No. 3,510,204; Hunsaker U.S. Pat. No. 1,842,403; Klearman U.S. Pat. No. 5,311,365 and Coleman U.S. Pat. No. 5,391,167.

It is also known to employ a light source to illuminate the area proximate the focal range of the magnifying lens. See, for example, Holoff U.S. Pat. No. 4,524,647.

However, none of the aforementioned tweezers can illuminate and magnify a retained object at the same time and be manipulated with one hand, leaving the other hand free to perform other tasks. Further, none is compact, light weight, easy to use and relatively inexpensive to produce.

It is, therefore, a prime object of the present invention to provide tweezers capable of illuminating and magnifying a retained object at the same time.

It is another object of the present invention to provide illuminated magnifying tweezers that can be manipulated with one hand, leaving the other hand of the user free to perform other tasks.

It is another object of the present invention to provide illuminated magnifying tweezers that are compact and light weight.

It is another object of the present invention to provide illuminated magnifying tweezers that are formed of simple parts that function together reliably and are relatively inexpensive to fabricate.

### BRIEF SUMMARY OF THE INVENTION

In general, the above objects are achieved by the present invention which are tweezers including first and second elongated object retaining members. Each of the retaining members has a forward section and a rear section. A body is situated between the retaining members. The body has first and second oppositely oriented sides. The rear section of each of the retaining members is attached to a different one of the oppositely oriented body sides.

The forward sections of the retaining members are movable between a position remote from each other and a position wherein the forward sections are proximate to each other, so as to retain an object therebetween. The body includes means for illuminating an object retained by the retaining members. The body also carries a magnifying lens and means for mounting the lens on the body for movement between a position aligned with the retained object and a position remote from the retained object.

The body encloses the illuminating means which takes the form of a light source. The body has a light transmitting surface facing the retained object such that the retained object is illuminated by the light source, when the light source is energized.

The forward sections of the retaining members are moveable substantially in a plane. The body has a top surface situated substantially in a plane parallel to, but spaced from, the plane of movement of the forward member sections. The lens mounting means is attached to the top body surface.

The lens mounting means preferably takes the form of means for rotationally mounting the lens on the top body surface.

The body also encloses a battery. Switch means are situated on the body for connecting the battery to light source.

The tweezers also include means for attaching the rear section of each of the retaining members to a different one of the oppositely directed body surfaces.

The forward sections of each of the retaining members are preferably inclined relative to the rear sections.

The means for mounting the lens includes a pin extending from the top body surface. An element is provided with an opening proximate one end thereof through which the pin is received. The lens is attached to the opposite end of the element.

In accordance with another aspect of the present invention, tweezers are provided including first and second retaining members. A body is situated between the retaining members. Illuminating means are mounted in the body. Magnifying means extend from the body.

The body has a front surface through which light from the illuminating means is directed and a top surface from which the magnifying means extends.

The tweezers also includes means for mounting the magnifying means on the body for movement between a position aligned with the retaining members and a position remote from the retaining members. The illuminating means illuminates a point aligned with the retaining members. The illuminated point is proximate the ends of the retaining members.

### BRIEF DESCRIPTION OF THE SEVERAL VIEWS OF DRAWINGS

To those and such objects which may herein after appear, the present invention relates to an illuminated magnifying tweezers, as described in detail in the following specification and recited in the annexed claims, taken together with the accompanying drawings, in which like numerals refer to like parts and in which:

FIG. 1 shows a convention tweezers in use;

FIG. 2 is an isometric view of the tweezers of the present invention, showing the magnifying lens in the retracted position;

FIG. 3 is a view similar to FIG. 2 showing the magnifying lens in the extended position;

FIG. 4 is a bottom view of the tweezers; and

FIG. 5 is an enlarged view of the tip of the tweezers as it appears through the magnifying lens.

### DETAILED DESCRIPTION OF THE INVENTION

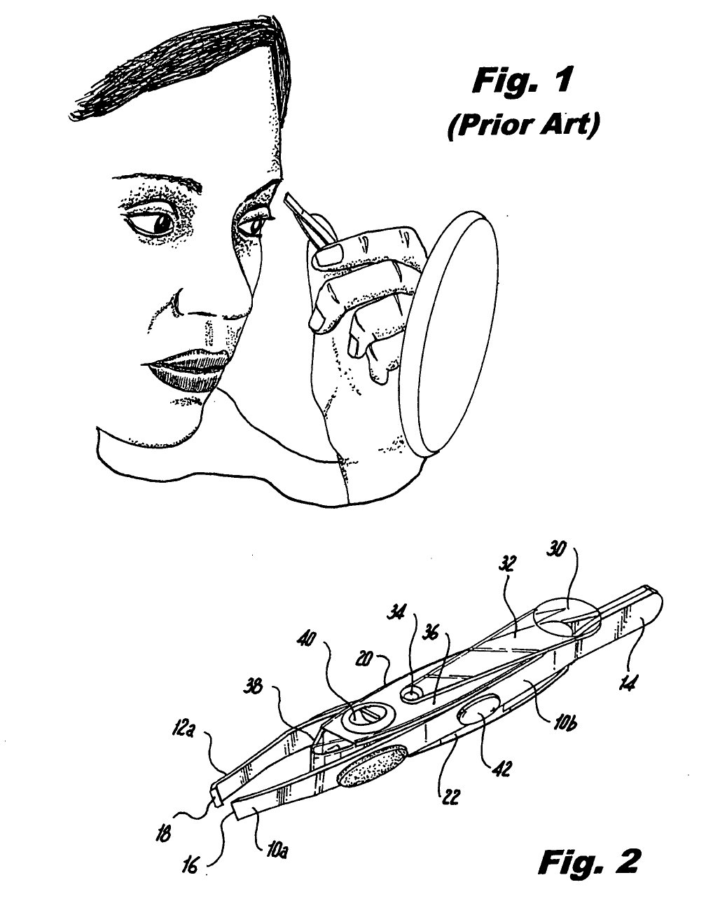

FIG. 1 illustrates the use of a conventional tweezers. Such tweezers are often used in conjunction with a mirror. The tweezers are held by the user with one hand, while the mirror is held in the other hand or mounted on a stand or to a wall.

Even if the mirror is illuminated and/or has a magnifying surface, the light is not focused on the object retained by the tweezers and it is difficult to center the focal point of the magnifying surface to coincide with the object retained by the tweezers. To obtain that result, the mirror would have to be held by the hand of the user not holding the tweezers and even then the hand of the user holding the tweezers would be situated between the tweezers and the mirror, partially obstructing the view.

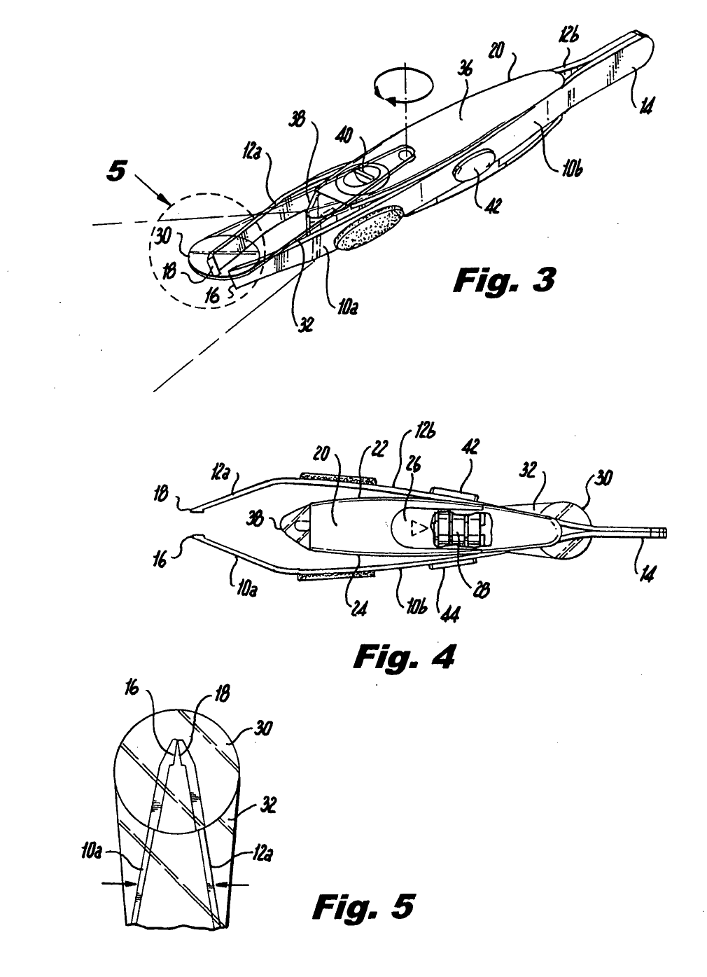

As illustrated in the FIGS. 2-5, the present invention overcomes the these difficulties by providing tweezers with illuminating and magnifying capability, that can be effectively used with one hand, allowing the other hand to be free to perform other tasks.

The tweezers of the present invention include first and second elongated object retaining members 10 and 12. Members 10 and 12 are connected together at one end 14 so as to form a “V” like structure, as is common with tweezers.

Members 10 and 12 are made of flexible material, for example, metal, such that the free ends 16, 18 thereof can be moved between a remote position, illustrated in FIGS. 2-4, and a proximate position, as shown in FIG. 5. An object may be retained between the retaining members when the ends 16, 18 of the members are in the proximate position.

Each of the retaining members 10, 12 has a forward section 10a, 12a and a rear section 10b, 12b, respectively. A hollow body 20, preferably made of plastic or similar material, is situated between the retaining members 10, 12.

Body 20 has first and second oppositely oriented side surfaces 22, 24. Each of the rear sections 10b, 12b of the retaining members 10, 12 is attached to a different one of the oppositely oriented body side surfaces 22, 24.

The forward sections 10a, 12a of the retaining members 10, 12 are movable from a position remote from each other (FIGS. 2-4) to a position wherein the forward sections 10a, 12a are proximate to each other (FIG. 5) by the application of inwardly directed forces squeezing the retaining members together. When the ends 16 and 18 of the retaining members 10, 12 are proximate each other, an object (not shown) can be retained therebetween.

Body 20 encloses a means for illuminating an object retained by the retaining members. The illuminating means preferably takes the form of a small incandescent bulb 26, but could be a light emitting diode or any other suitable light source. Body 22 also encloses a battery 28 for energizing bulb 26.

Aside from the light source, body 20 also carries magnifying means in the form of a circular magnifying lens 30. Means are provided for rotationally mounting lens 30 to body 20, in the form of a plastic element 32. That element is preferably integral with lens 30. Lens 30 is situated at one end of element 32.

The other end of element 32 has an opening through which a pin 34 extends. Pin 34 has an enlarged head. The end of pin 34 is fixed to top surface 36 of body 20. Thus, element 32 is rotationally mounted on surface 36 of body 20 for movement in a plane parallel to top surface 36 between a position where lens 30 is aligned with the point between retaining member ends 16, 18, such that the focal point of the lens coincides with the point where an object retained by members 10, 12 would be situated (FIGS. 3 and 5), and a position remote from that point (FIG. 2).

The forward end of body 20 has a light transmitting surface 30 facing the ends 16, 18 of members 10, 12 between which an object could be retained. Thus, the retained object is illuminated by light source 26 within body 20, through surface 30, when light source 26 is energized by connecting it to battery 28 through switch 40 situated on top surface 36 of body 20.

The forward sections 10a, 12a of the retaining members 10, 12 are moveable substantially in a plane. The top surface 36 of body 20, to which element 32 is rotationally mounted, is situated substantially in a plane parallel to, but spaced from, the plane of movement of the forward retaining member sections. That configuration permits lens 32 to be aligned and closely positioned with respect to an illuminated object retained by the tweezers.

Conventional means, such as adhesive, or preferably, as illustrated, pins with enlarged heads 42, 44 may be used to fix body 20 between the retaining members. The shafts of the pins extend through openings in the rear sections 10b, 12b of the retaining members, to fix body 20 between the retaining members. More specifically, the shaft of pin with head 42 extends through an opening in retaining member section 10b and is fixed to surface 22 of body 20. Similarly, the shaft of pin with head 44 extends through an opening in retaining member section 12b and is fixed to surface 24 of body 20.

In each of the retaining members 10, 12, the forward sections 10a, 12a are bent with respect to rear sections 10b, 12b, respectively. Accordingly, forward section 10a is inclined relative to rear section 10b and forward section 12a is inclined relative to rear section 12b. This permits the ends 16, 18 of the retaining members to meet when the retaining members are squeezed together (see FIG. 5) even though body 20 is situated between the retaining members.

It will now be appreciated that the present invention relates to tweezers including first and second elongated object retaining members. Each of the retaining members has a forward section and a rear section. A body is situated between the retaining members. The body has first and second oppositely oriented sides. The rear section of each of the retaining members is attached to a different one of the oppositely oriented body sides. The forward sections of the retaining members are movable between a position remote from each other and a position wherein the forward sections are proximate to each other, so as to retain an object therebetween.

The body includes means for illuminating an object retained by the retaining members. The body also carries a magnifying lens and means for mounting the lens on the body for movement between a position aligned with the retained object and a position remote from the retained object. The present invention therefore permits the user to illuminate and magnify a retained object using one hand, while the other hand is free to perform other tasks.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A tweezers comprising first and second elongated object retaining members, each of said retaining members having a forward section and a rear section, a body situated between said retaining members, said body having first and second oppositely oriented sides, said rear section of each of said retaining members being attached to a different one of said oppositely oriented body sides, said forward sections of said retaining members being movable between a position wherein said forward sections are remote from each other and a position wherein said forward sections are proximate each other so as to retain an object therebetween, said body comprising means for illuminating an object retained by said retaining members, magnifying means and means for mounting said magnifying means on said body for movement between a position aligned with the retained object and a position remote from the retained object.

2. The tweezers of claim 1 wherein said body encloses said illuminating means.

3. The tweezers of claim 1 wherein said illuminating means comprises a light source.

4. The tweezers of claim 3 wherein said body has a light transmitting surface facing the retained object such that the retained object is illuminated by the light source when the light source is energized.

5. The forward sections of the retaining members are moveable substantially in a plane. The body has a surface situated substantially in a plane parallel to, but spaced from, the plane of movement of the member sections. The lens mounting means is attached to the body surface.

6. The tweezers of claim 1 wherein said magnifying means mounting means comprises means for rotationally mounting a lens on the body surface.

7. The tweezers of claim 3 wherein said body further comprises a battery and switch means for connecting the battery to said light source.

8. The tweezers of claim 1 further comprising means for attaching said rear section of each of said retaining members to said oppositely directed body sides.

9. The tweezers of claim 1 wherein said forward section of each of said retaining members is inclined relative to said rear section.

10. The tweezers of claim 6 wherein said means for rotationally mounting a lens comprises a pin extending from said body surface, an element with an opening proximate one end through which said pin is received, said lens being attached to the opposite end of said element.

11. A tweezers including first and second retaining members, a body situated between said retaining members, illuminating means mounted in said body and magnifying means extending from said body.

12. The tweezers of claim 11 wherein said body has a first surface through which light from said illuminating means is directed and a second surface from which said magnifying means extends.

13. The tweezers of claim 11 comprising means for mounting said magnifying means on said body for movement between a position aligned with said retaining members and a position remote from said retaining members.

14. The tweezers of claim 11 wherein said illuminating means illuminates a point aligned with said retaining members.

15. The tweezers of claim 14 wherein said point is proximate the ends of said retaining members.
